(19) United States
(12) Patent Application Publication
(10) Pub. No.: US 2011/0021141 A1
(43) Pub. Date: Jan. 27, 2011

(54) ELECTRONIC DEVICE FOR ELECTRIC-FIELD COMMUNICATION

(76) Inventors: Hiroyuki Hebiguchi, Miyagi-ken (JP); Masahito Nakamura, Miyagi-ken (JP); Makoto Sasaki, Miyagi-ken (JP); Daichi Inoue, Miyagi-ken (JP)

Correspondence Address: BRINKS HOFER GILSON & LIONE, P.O. BOX 10395, CHICAGO, IL, 60610, US

(21) Appl. No.: 12/895,269

(22) Filed: Sep. 30, 2010

Related U.S. Application Data
(63) Continuation of application No. PCT/JP2009/056445, filed on Mar. 30, 2009.

(30) Foreign Application Priority Data
Apr. 2, 2008 (JP) 2008-095988

(51) Int. Cl. H04B 5/00

(52) U.S. Cl. 455/41.1

(57) ABSTRACT

Provided is an electronic device for electric-field communication which is not easily affected by static electricity when electrostatically charged and is capable of maintaining sufficient performance. The electronic device for electric-field communication of the invention is an electronic device used as a transmitter 1 or a receiver 3 in a system of performing electric field communication through a human body 2, the electronic device has at least human body side electrodes 11 and 31 and outside electrodes 12 and 32, and impedance between the human body side electrodes 11 and 31 and the outside electrodes 12 and 32 is substantially the maximum at a frequency f₀ used in the electric field communication.

### RELATED APPLICATIONS

This application is a Continuation of International Application No. PCT/JP2009/056445 filed on Mar. 30, 2009, which claims benefit of Japanese Patent Application No. 2008-095980 filed on Apr. 2, 2008, both of which are hereby incorporated by reference.

### BACKGROUND OF THE INVENTION

1. Field of the Invention

The present invention relates to an electronic device for electric-field communication used in a system transmitting and receiving electric field signals through a transmission medium such as a human body and a space.

2. Description of the Related Art

As for a communication system performing transmission and reception through a transmission medium (mainly, a human body), a communication method using an electric field is disclosed in Patent Literature 1 and the like. In the system disclosed in Patent Literature 1, each of a transmitter and a receiver is provided with an electrode pair, that is, a pair of human body side (internal) electrode closely and capacitively coupled with a human body, and an outside (external) electrode arranged to be opposed to each other such that a coupling with a room earth is larger than that of the human body side (internal) electrode.

Regarding the various roles described above, as shown in FIG. 9, an electrode pair 92 is opposed to a surface of an electronic device 91 or the vicinity thereof, for example, there are many cases where one is disposed on a surface, and the other is disposed on a bottom surface. As electronic devices for such a communication system, there are a mobile phone, a portable game device, and an electronic key and an IC card represented by a car remote hand set system, and such electronic devices are required to be thin.

[Patent Citation 1] PCT Japanese Translation Patent Publication No. 11-509380

During investigation of applications such as a card type key, it is known that, as shown in FIG. 10, when a person 102 charged with static electricity takes up a key placed on a conductive desk 101, an outside electrode 103 or a human body side electrode 104 is touched with a finger, high voltage is applied to a circuit in the card, and thus a problem occurs in operation, or electrostatic breakdown 105 occasionally occurs. Such a problem occurs even when a person charged with static electricity takes up a mobile device in a case where the mobile device is detached from a charger after a mobile device applying human body communication is charged.

This problem becomes conspicuous, in the card application, by the following, for example, the electrode is disposed on a surface as possible as it can in order to make coupling between the human body and the electrode large to stabilize communication even in a state where it is put in a pocket or the like, electrode areas are made substantially equal such that a front surface and a back surface may not be discriminated between, and a distance between the human body side electrode and the outside electrode is short to make the card thinner or the like. Accordingly, a countermeasure is necessary.

### SUMMARY OF THE INVENTION

The invention has been made in consideration of such issues, and an object of the invention is to provide an electronic device for electric-field communication, which is not easily affected by static electricity and is capable of maintaining sufficient performance, even when electrostatically charged.

An electronic device for electric-field communication of the invention is an electronic device used as a transmitter or a receiver in a system of communicating in electric field through a transmission medium, the electronic device including at least a transmission medium side electrode and an outside electrode, wherein impedance between the transmission medium side electrode and the outside electrode is substantially maximum at a frequency used in the electric field communication.

With such a configuration, the impedance between the transmission medium side electrode and the outside electrode becomes small at frequencies other than the frequency used in the electric field communication. Even when it comes into contact with an electrode when electrostatically charged, the charges can be allowed to escape, and it is possible to prevent an influence of the static electricity on the electronic device. This advantage is effective even when the electronic device is used for a transmitter and is used for a receiver. Meanwhile, in a frequency band used in the electric field communication, since the impedance between the transmission medium side electrode and the outside electrode becomes the maximum, a loss with the capacitance interposed between the transmission medium side electrode and the outside electrode is reduced. When the electronic device is used as the transmitter, transmission efficiency is improved, and when the electronic device is used as the receiver, reception sensitivity is improved. For this reason, as a system, communication quality is improved. In addition, by substantially equally suppressing the communication quality and reducing power consumption of the transmitter, it is possible to extend battery lifespan.

In the electronic device for electric-field communication of the invention, it is preferable that a circuit board for electric-field communication is provided between the transmission medium side electrode and the outside electrode, the circuit board is connected to one electrode of the transmission medium side electrode and the outside electrode, and the other electrode is capacitively coupled with a ground of the circuit board.

In the electronic device for electric-field communication of the invention, it is preferable that an inductor constituting a parallel resonant circuit with electrostatic capacitance between the transmission medium side electrode and the outside electrode is provided, and a resonant frequency of the parallel resonant circuit is substantially the same as a frequency used in the electric field communication.

With such a configuration, since the parallel resonant circuit is configured by the capacitance and the inductor between the transmission medium side electrode and the outside electrode, a Q value of the resonant circuit is high, it is possible to markedly reduce the impedance in frequencies other than the frequency used in the electric field communication, and the effect as an electrostatic countermeasure becomes high. In addition, in the frequency band used in the electric field communication, since the impedance gets higher, the transmission efficiency is improved, the reception sensitivity is further improved, and the communication quality is further improved.

In the electronic device for electric-field communication of the invention, it is preferable that a capacitance coupling member is provided between the transmission medium side electrode and the outside electrode, and impedance for electrostatic capacitance with the capacitance coupling member interposed therebetween is substantially maximum in the frequency used in the electric field communication.

When the capacitance coupling member such as a board and components between the transmission medium side electrode and the outside electrode is provided, it is conceivable that unexpected voltage may occur due to the electrostatic capacitance with the board and the components interposed therebetween, and electrostatic breakdown or the like may occur. With such a configuration, even for the electrostatic capacitance between the capacitance coupling members, the impedance becomes the maximum in the frequency band used in the electric field communication and becomes small in the frequencies other than the frequency, and thus it is possible to significantly obtain the above-described effect.

In the electronic device for electric-field communication of the invention, it is preferable that the electronic device is provided with a plurality of cases taking a plurality of postures, and has control means for controlling capacitance or inductance such that the impedance between the transmission medium side electrode and the outside electrode in the postures is substantially the maximum at the frequency used in the electric field communication. With such a configuration, for example, even in an electronic device such as a foldable mobile phone, a sufficient electrostatic countermeasure is provided even in any of a plurality of postures of an opened state and a folded state, and it is possible to obtain satisfactory communication quality.

The electronic device for electric-field communication of the invention is an electronic device used as a transmitter or a receiver in a system of communicating in electric field through a transmission medium, the electronic device includes at least a transmission medium side electrode and an outside electrode, and impedance between the transmission medium side electrode and the outside electrode is substantially the maximum at a frequency used in the electric field communication. Accordingly, even when electrostatically charged, it is not easily affected by the static electricity, and it is possible to maintain sufficient performance.

### BRIEF DESCRIPTION OF THE DRAWINGS

FIG. 1 is a schematic diagram illustrating a configuration of an electric field communication system using an electronic device according to an embodiment of the invention.

FIGS. 2(a) and (b) are schematic diagrams illustrating a basic configuration of an electronic device for electric-field communication according to the embodiment of the invention.

FIG. 3 is a diagram for explaining impedance in the electronic device for electric-field communication according to the embodiment of the invention.

FIGS. 4(a) and (b) are schematic diagrams illustrating the electronic device for electric-field communication according to the embodiment of the invention.

FIG. 5 is a diagram for explaining an inductance transistor introduced between a human body side electrode and an outside electrode.

FIG. 6 is a diagram for explaining a stub introduced between the human body side electrode and the outside electrode.

FIG. 7 is a diagram for explaining a capacitance coupling member in the electronic device for electric-field communication.

FIGS. 8(a) to (c) are diagrams illustrating postures between cases of a foldable mobile phone that is an electronic device for electric-field communication.

FIG. 9 is a diagram illustrating an example of an electronic device for electric-field communication.

FIG. 10 is a diagram for explaining a problem in the electronic device for electric-field communication shown in FIG. 9.

### EXPLANATION OF REFERENCE

1: TRANSMITTER
2: TRANSMISSION MEDIUM
3: RECEIVER
4: EARTH
11, 31: HUMAN BODY SIDE ELECTRODE
12, 32: OUTSIDE ELECTRODE
13, 33, 43: CIRCUIT BOARD FOR ELECTRIC-FIELD COMMUNICATION
41: STUB
42: OTHER CIRCUIT BOARD
44: BATTERY
51, 52: CASE

### DESCRIPTION OF THE PREFERRED EMBODIMENTS

It is assumed that, as an electronic device used in an electric field communication system gets smaller as in an IC card or various keys, there are many cases where a transmission medium side electrode and an outside electrode are opposed as described above, capacitance (capacitance Csg between signal electrode and reference electrode) between the transmission medium side electrode and the outside electrode cannot be reduced, and thus electric field signals are lost through the capacitance Csg.

Paying attention to such a point, the inventors found that the loss of electric signals with the capacitance Csg interposed therebetween can be suppressed by introducing inductance L between the transmission medium side electrode and the outside electrode to make parallel resonance with the capacitance Csg between the transmission medium side electrode and the outside electrode, and made the invention.

That is, the main point of the invention is that an electronic device used as a transmitter or a receiver in a system of communicating in electric field through a transmission medium includes at least a transmission medium side electrode and an outside electrode, impedance between the transmission medium side electrode and the outside electrode is substantially the maximum at a frequency used in the electric field communication, it is not easily affected by static electricity even when electrostatically charged, and sufficient performance is maintained.

Hereinafter, embodiments of the invention will be described in detail with reference to the accompanying drawings.

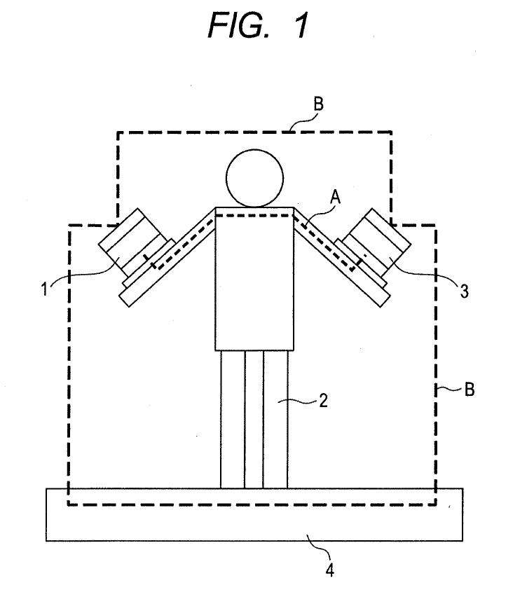

FIG. 1 is a diagram for explaining an electric field communication system using an electronic device according to an embodiment of the invention.

As described above, in the electric field communication system performing transmission and reception through a transmission medium (mainly, a human body) 2, each of a transmitter 1 and a receiver 3 is provided with a pair of a human body side (internal) electrode closely and capacitively coupled with the human body 2 and an outside (external) electrode arranged such that coupling with an earth 4 is larger than that of the human body side (internal) electrode. In addition, in human body communication using an electric field, an outgoing path (path A in FIG. 1) in which a signal flows through the capacitance coupling of a transmitter-human body-receiver, and a returning path (path B in FIG. 1) in which a signal flows through the capacitance coupling of receiver-dielectric such as air or a conductor such as a ground-receiver are necessary.

In such an electric field communication system, in the transmitter 1, for example, a data signal is modulated into a carrier wave of a frequency (several hundreds kHz to several tens MHz) at which a human body exhibits conductivity, thereby obtaining a modulated signal. The modulated signal is amplified and converted by a change in voltage to be an electromagnetic field signal corresponding to the modulated signal. The electric field signal is applied to the human body that is the transmission medium 2. In addition, a modulation method in the transmitter 1 is not particularly limited. The electric field signal applied to the human body is received through a signal electrode of the receiver 3. The electric field signal entering the signal electrode is amplified and demodulated using the carrier wave used in the transmitter 1, and is output as a data signal.

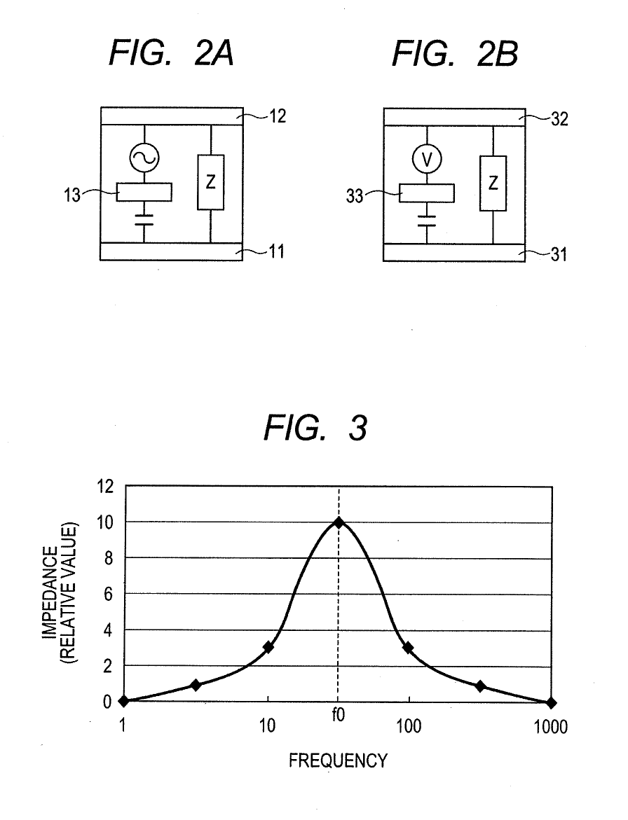

FIG. 2(a) is a schematic diagram illustrating an electronic device used as the transmitter 1 in the system shown in FIG. 1, and FIG. 2(b) is a schematic diagram illustrating an electronic device used as the receiver 3 in the system shown in FIG. 1. The transmitter 1 or the receiver 3 that is the electronic device each has at least transmission medium side electrodes (herein, human body side electrodes) 11 and 31 and outside electrodes 12 and 32. Circuit boards 13 and 33 for electric-field communication are provided between the transmission medium side electrodes (herein, human body side electrodes) 11 and 31 and the outside electrodes 12 and 32, respectively. In this configuration, although the human body side electrodes 11 and 31 and the outside electrodes 12 and 32 are connected through an impedance element Z, as shown in FIG. 3, impedance is substantially the maximum at a frequency f₀ used in electric field communication.

In addition, it is preferable that a band in which frequency is generally reduced from a peak to −3 dB covers the frequency used in the electric field communication. The circuit boards 13 and 33 for electric-field communication are connected to the electrodes on one side (herein, outside electrodes 12 and 32), respectively, and the electrodes on the other side (herein, human body side electrodes 11 and 31) are capacitively coupled with grounds of the circuit boards 13 and 33 for electric-field communication, respectively.

With such a configuration, the impedance between the human body side electrodes 11 and 31 and the outside electrodes 12 and 32 becomes low in frequencies other than the frequency used in the electric field communication. Even when it comes into contact with an electrode when electrostatically charged, the static electricity does not flow to the circuit boards 13 and 33 for electric-field communication and flows to the impedance elements Z, the charge can escape, and it is possible to prevent the static electricity having an influence on the electronic device. Meanwhile, in the frequency band used in the electric field communication, since the impedance between the human body side electrodes 11 and 31 and the outside electrodes 12 and 32 becomes the maximum, a loss with the capacitance interposed between the human body side electrodes 11 and 31 and the outside electrodes 12 and 32 is reduced. Accordingly, when the electronic device is used as the transmitter, transmission efficiency is improved, and when the electronic device is used as the receiver, reception sensitivity is improved. For this reason, as a system, communication quality is improved. In addition, by equally suppressing the communication quality and reducing power consumption of the transmitter, it is possible to extend battery life.

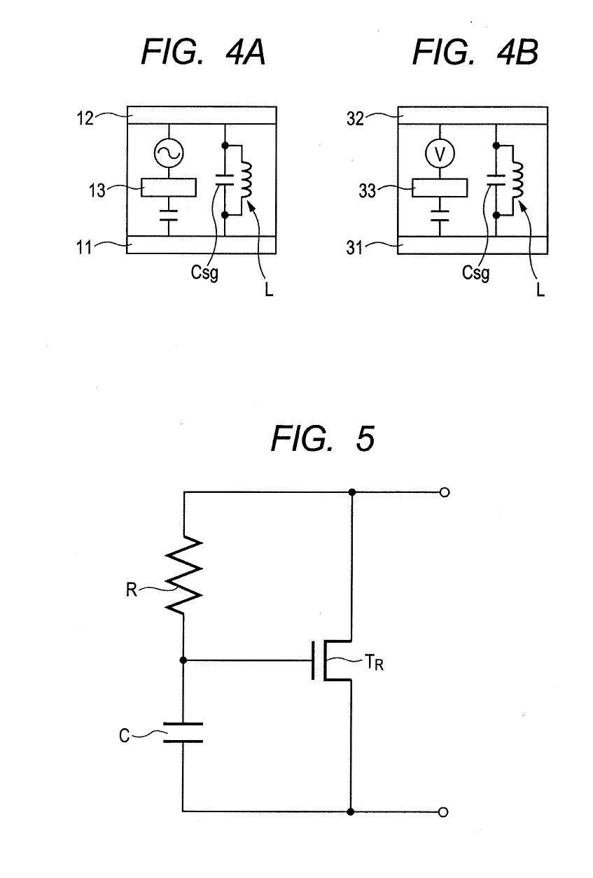

To make the impedance Z between the human body side electrodes 11 and 31 and the outside electrodes 12 and 32 substantially the maximum in the frequency fₒ used in the electric field communication, for example, as shown in FIGS. 4(a) and (b), an inductor L constituting a parallel resonant circuit with electrostatic capacitance between the human body side electrodes 11 and 31 and the outside electrodes 12 and 32 is provided, and a resonant frequency of the parallel resonant circuit is made substantially equal to the frequency used in the electric field communication. In this case, by using a air-core coil or the like with a large Q value as the inductor L, the transmission efficiency in the electric field communication system is improved, as well as the effect of improving the reception sensitivity become greater. In this case, it is preferable that the inductance L is set to a value of resonating with Csg when the transmitter and the receiver as the electronic device are mounted on the human body.

Even in this case, the circuit boards 13 and 33 for electric-field communication are provided between the transmission medium side electrodes (herein, human body side electrodes) 11 and 31 and the outside electrodes 12 and 32, respectively, the circuit boards 13 and 33 for electric-field communication are connected to the electrodes on one side (herein, outside electrodes 12 and 32), respectively, and the electrodes on the other side (herein, human body side electrodes 11 and 31) are capacitively coupled with grounds of the circuit boards 13 and 33 for electric-field communication, respectively. Accordingly, the impedance between the human body side electrodes 11 and 31 and the outside electrodes 12 and 32 becomes low at frequencies other than the frequency used in the electric field communication. Even when it comes into contact with an electrode when electrostatically charged, the static electricity does not flow to the circuit boards 13 and 33 for electric-field communication and flows to the impedance elements Z, the charge can escape, and it is possible to prevent the static electricity having an influence on the electronic device. Meanwhile, in the frequency band used in the electric field communication, since the impedance between the human body side electrodes 11 and 31 and the outside electrodes 12 and 32 becomes the maximum, a loss with the capacitance interposed between the human body side electrodes 11 and 31 and the outside electrodes 12 and 32 is reduced. Accordingly, when the electronic device is used as the transmitter, transmission efficiency is improved, and when the electronic device is used as the receiver, reception sensitivity is improved. For this reason, as a system, communication quality is improved. In addition, by equally suppressing the communication quality and reducing power consumption of the transmitter, it is possible to extend battery life.

In addition to the configuration shown in FIG. 4, as shown in FIG. 5, a parallel resonant circuit may be configured as described above using an inductance transistor. When the electronic device is the IC card or the various keys, it is required to have a thinner frame and to be small. Accordingly, it is preferable that constituent components are made into a semiconductor chip. However, it is difficult to make a coil using a semiconductor process. The coil is large even when it is forcibly formed, and a cost is also increased. However, as shown in FIG. 5, when a transistor circuit serving as inductance is used without using the coil, it is easy to make components into a semiconductor chip, and elements are made small, thereby being inexpensive. In addition, to allow the transistor circuit to serve as the inductance, a CR time constant is sufficiently large, thus satisfying ωCR>>1 which is a condition.

Although FIG. 5 shows an example of a basic configuration of the inductor transistor, any transistor circuit serving as inductance can be used in addition to a transistor circuit studied for raising the Q value. The inductance transistor can control an inductance value, and thus it is possible to configure it to be automatically controlled such that the impedance is the maximum even when electrostatic capacitance is varied.

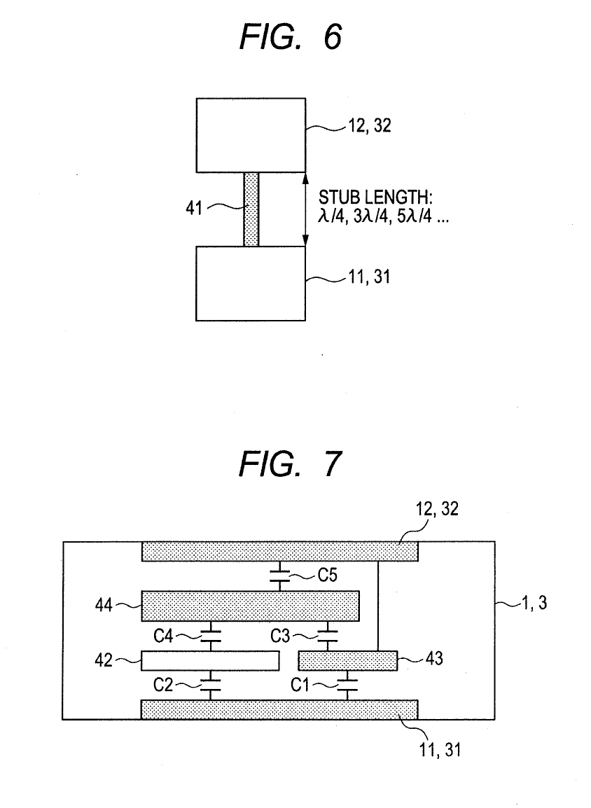

As shown in FIG. 6, as for a wavelength λ in the frequency used in the electric field communication, even when a short stub 41 having a length of λ/4, 3λ/4, 5λ/4 . . . is provided between the human body side electrodes 11 and 31 and the outside electrodes 12 and 32, the impedance can be maximum. Particularly, when the frequency used in the electric field communication is high, it is sufficient if a wavelength is short and a stub is of a small size. Accordingly, the configuration using the stub 41 is effective. In addition, it is possible to configure a parallel resonant circuit using the stub 41 as inductance. In this case, it is not limited to the short stub, and an open stub may be used. Moreover, a notch filter (or a band elimination filter) may be used. Even using such a filter, input impedance can be high at the frequency used in the electric field communication and the input impedance can be markedly low at the other frequencies, and thus it is possible to exhibit the advantage of the invention.

As described above, since the parallel resonant circuit is configured by the capacitance and the inductor between the human body side electrodes 11 and 31 and the outside electrodes 12 and 32, the Q value of the resonant circuit is high, the impedance can be markedly reduced in frequencies other than the frequency used in the electric field communication, and it is possible to exhibit an effect of an electrostatic countermeasure. In the frequency band used in the electric field communication, since the impedance gets higher, the transmission efficiency is improved, the reception sensitivity is improved, and the communication quality is further improved.

In the electronic device, as shown in FIG. 7, the electric field communication human body side electrodes 11 and 13, the outside electrodes 12 and 32, the circuit board 43 for electric-field communication that is a capacitance coupling member, the circuit board 42, the battery 44, and the like are mounted with high density, and the distance between them becomes very small. In the conventional large electronic device, the distance between them is large, and it was not necessary to consider a negative influence caused by static electricity. However, in an electronic device (IC card or various keys) which is small and has a thin frame required to be mounted with high density, the distance between components becomes very small, and it is important to optimize the impedance as described in the invention.

For this reason, it is preferable that there is a capacitance coupling member between the human body side electrodes 11 and 31 and the outside electrodes 12 and 32, and the impedance for the electrostatic capacitances C1 to C5 with the capacitance coupling member interposed therebetween is substantially the maximum at the frequency used in the electric field communication. That is, when the impedance between the human body side electrodes 11 and 31 and the outside electrodes 12 and 32 is the maximum at the frequency band used in the electric field communication and the impedance is small at the other frequencies, it is necessary to consider a composite capacitance of the electrostatic capacitances C2 to C5 shown in FIG. 7 in regards to a part to which the inductor L or the like is introduced. In this case, although it is satisfactory that it is introduced to one place after considering the composite capacitance of the electrostatic capacitances C2 to C5, it is effective that the inductor L is dispersed and introduced according to each capacitance. Accordingly, even for the electrostatic capacitance between the capacitance coupling members, the impedance becomes the maximum in the frequency band used in the electric field communication and becomes small in the other frequencies, and thus it is possible to reliably obtain the above-described effect.

As described above, it is important that the impedance is made the maximum in the frequency used in the electric field communication considering the individual capacitance coupling member, even from the viewpoint of improving the communication quality. Particularly, for a use of the IC card or the like, it is necessary to consider coupling through a battery, in addition to the direct coupling between the outside electrode and the human body side electrode. In this case, such a configuration is very effective.

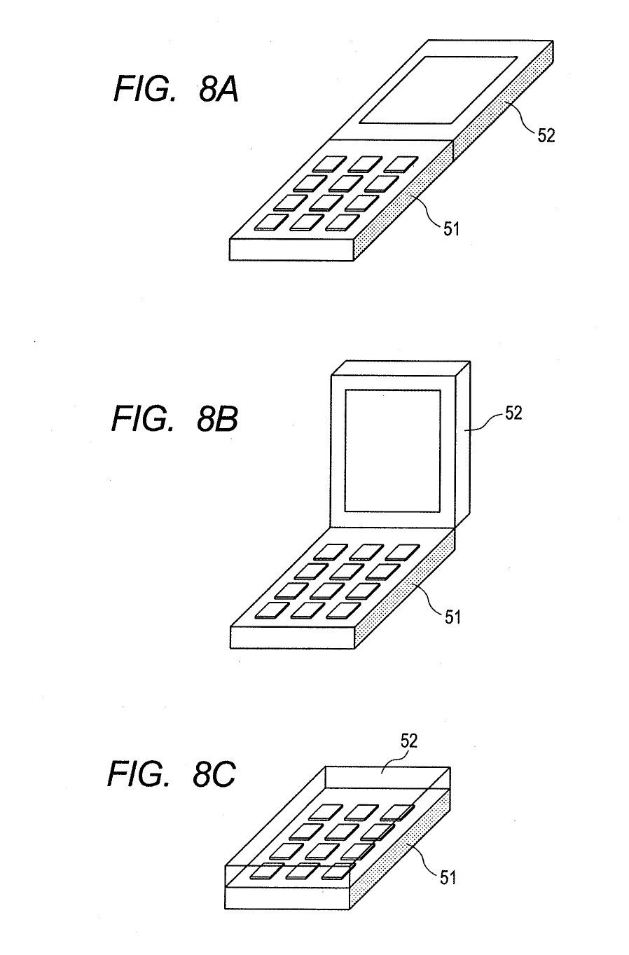

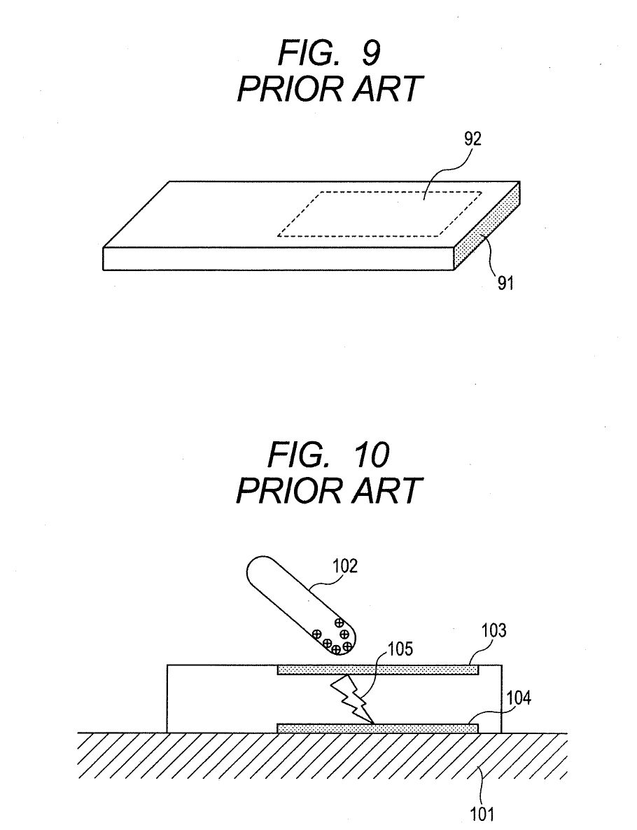

A case where the electronic device is a foldable mobile phone as shown in FIGS. 8(a) to (c) will be described. FIG. 8(a) shows an opened state of two cases, FIG. 8(c) shows a closed state of the two cases, and FIG. 8(c) shows an intermediate state thereof. When the outside electrode is provided in a case 51 on the LCD side and the human body side electrode is provided in a case 52 on the input unit side, electrostatic capacitance is different between the human body side electrode and the outside electrode, that is, the opened state (FIG. 8(a))<the intermediate state (FIG. 8(b))<the closed sate (FIG. 8(c)).

In the electronic device provided with a plurality of cases (herein, 2) taking a plurality of postures, it is preferable to control capacitance or inductance such that the impedance between the human body side electrode and the outside electrode in the postures is substantially the maximum in the frequency used in the electric field communication. With such a configuration, a sufficient electrostatic countermeasure is provided everywhere, such as the plurality of postures of the opened state and the folded state, and thus it is always possible to obtain good communication quality.

That is, when the electrostatic capacitance is different between the human body side electrode and the outside electrode according to the postures between the cases, the inductance values for making the impedance maximum are different from each other. For this reason, it is preferable to provide a control unit (not shown), which learns in advance the electrostatic capacitance values in the postures to change the inductance value to the optimal inductance value according to the postures. In this case, the postures between the cases are detected by an open and close sensor or the like. Alternatively, the electronic device may be provided with a function of detecting the electrostatic capacitance for the postures, and the control unit may automatically control the optimal inductance value according to the detected electrostatic capacitance. In this case, it is preferable to use an inductance transistor capable of controlling an inductance value, as an inductor. In addition, change of electrostatic capacitance between the human body side electrode and the outside electrode may be offset using variable capacitance to make the impedance the maximum.

In the example of the mobile phone, since the case of performing the electric field communication in a state where it is folded and put in a pocket is assumed, it is possible to perform stable communication irrespective of the direction of the mobile phone, by making the electrostatic capacitance between the human body and the electrode be substantially the same regardless of whether the human body side electrode or the outside electrode is positioned close to the human body. Specifically, it is preferable to make an area of the human body side electrode and an area of the outside electrode equal, or to control a thickness of a case or a dielectric constant such that the electrostatic capacitance is the same when the area of the human body side electrode is different from the area of the outside electrode.

The invention is not limited to the embodiment, and may be variously modified and embodied. For example, the circuit configuration, the number of components, the numerical values, and the like in the embodiment are examples, the invention is not limited thereto, and may be appropriately modified and embodied. In addition, the invention may be appropriately modified and embodied without deviating from the scope of the invention.

What is claimed is:

1. An electronic device for electric-field communication used as a transmitter or a receiver in a system of communicating in electric field through a transmission medium, the electronic device comprising at least a transmission medium side electrode and an outside electrode, wherein impedance between the transmission medium side electrode and the outside electrode is substantially maximum at a frequency used in the electric field communication.

2. The electronic device for electric-field communication according to claim 1, wherein a circuit board for electric-field communication is provided between the transmission medium side electrode and the outside electrode, the circuit board is connected to one electrode of the transmission medium side electrode and the outside electrode, and the other electrode is capacitively coupled with a ground of the circuit board.

3. The electronic device for electric-field communication according to claim 1, further comprising an inductor constituting a parallel resonant circuit with electrostatic capacitance between the transmission medium side electrode and the outside electrode,
wherein a resonant frequency of the parallel resonant circuit is substantially the same as a frequency used in the electric field communication.

4. The electronic device for electric-field communication according to claim 1, further comprising a capacitance coupling member provided between the transmission medium side electrode and the outside electrode,
wherein impedance for electrostatic capacitance with the capacitance coupling member interposed therebetween is substantially maximum in the frequency used in the electric field communication.

5. The electronic device for electric-field communication according to claim 1, further comprising a plurality of cases taking a plurality of postures, and control means for controlling capacitance or inductance such that the impedance between the transmission medium side electrode and the outside electrode in the postures is substantially maximum in the frequency used in the electric field communication.
